(19) United States
(12) Patent Application Publication
(10) Pub. No.: US 2026/0333489 A1
(43) Pub. Date: Oct. 22, 2026

(54) RADIO LINK FAILURE DETECTION IN MULTIPATH OPERATION

(71) Applicant: INTERDIGITAL PATENT HOLDINGS, INC., Wilmington, DE (US)

(72) Inventors: Oumer Teyeb, Montreal (CA); Martino Freda, Laval (CA); Tuong Hoang, Montreal (CA); Ananth Kini, Conshohocken, PA (US)

(73) Assignee: INTERDIGITAL PATENT HOLDINGS, INC., Wilmington, DE (US)

(21) Appl. No.: 19/101,449

(22) PCT Filed: Aug. 4, 2023
(86) PCT No.: PCT/US2023/029555

§ 371 Date: Feb. 5, 2025

Related U.S. Application Data
(60) Provisional application No. 63/395,603, filed on Aug. 5, 2022.

(51) Int. Cl. H04W 76/18; H04B 17/318

(52) U.S. Cl. CPC H04W 76/18; H04B 17/328

(57) ABSTRACT

Systems, methods, and instrumentalities are described herein for radio link failure (RLF) detection in scenarios where a remote WTRU is connected with the network via multipath link composed of a direct link and a relayed link (e.g., via a relay WTRU connected to the remote WTRU via a sidelink, SL). A remote WTRU may be configured to modify the RLF detection parameters 2024/030653 of the direct link (e.g., RLF timer and counter values) based on the conditions on the relayed link such as SL radio quality (e.g., SL RSRP, SL RSRQ, etc.,) or/and SL congestion (e.g., CBR, CR, etc.). A remote WTRU may be configured to modify the RLF detection parameters of the SL (e.g., maximum HARQ DTX value) based on the conditions on the direct link (e.g., RSRP, RSRQ, etc. ,) and/or SL congestion (e.g., CBR, CR, etc.).

### CROSS-REFERENCE TO RELATED APPLICATIONS

This application claims the benefit of U.S. Provisional Application No. 63/395,603, filed Aug. 5, 2022, the contents of which are incorporated herein by reference.

### BACKGROUND

Radio link failure detection is an important technology in wireless communications. This technology enables the detection of radio link failures that may be caused for a number of reasons, such as fading, interference, coverage and the like. This technology is crucial for efficiently and quickly addressing when such impairments occur. There is a need for improvement on such technologies as wireless communication advances.

### SUMMARY

Systems, methods, and instrumentalities are described herein for radio link failure (RLF) detection in scenarios where a remote WTRU is connected with the network via multipath link composed of a direct link and a relayed link (e.g., via a relay WTRU connected to the remote WTRU via a sidelink, SL). A remote WTRU may be configured to modify the RLF detection parameters of the direct link (e.g., RLF timer and counter values) based on the conditions on the relayed link such as SL radio quality (e.g., SL RSRP, SL RSRQ, etc.,) or/and SL congestion (e.g., CBR, CR, etc.,). A remote WTRU may be configured to modify the RLF detection parameters of the SL (e.g., maximum HARQ DTX value) based on the conditions on the direct link (e.g., RSRP, RSRQ, etc.,) or/and SL congestion (e.g., CBR, CR, etc.,).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a protocol perspective of split bearers;

FIG. 3 illustrates an example of a user plane protocol stack for L2 WTRU-to-Network relay;

FIG. 4 illustrates an example of a control plane protocol stack for L2 WTRU-to-Network relay;

FIG. 5 illustrates an example of a multipath scenario of a same cell;

FIG. 6 illustrates an example of a multipath scenario of a different cell;

FIG. 7 illustrates an example of Radio Link Monitoring (RLM) and Radio Link Failure (RLF) detection mechanisms;

FIG. 8 illustrates an example of a radio link failure in a WTRU relay scenario;

FIG. 9 illustrates an example of a RLF process according to one or more approaches described herein; and

FIG. 10 illustrates an example of a RLF process according to one or more approaches described herein;

### DETAILED DESCRIPTION

The following provides a non-exhaustive list of acronyms that may be used herein: ACK—Acknowledgement; BLER—Block Error Rate; CB—Contention-Based (e.g. access, channel, resource); CBR—Channel Busy Ratio; CP—Cyclic Prefix; CP-OFDM—Conventional OFDM (relying on cyclic prefix); CQI—Channel Quality Indicator; CR—Channel Occupancy Ratio; CRC—Cyclic Redundancy Check; CSI—Channel State Information; D2D—Device to Device transmissions (e.g. LTE Sidelink); DCI—Downlink Control Information; DCR—Direct Communication Request; DFT-s-OFDM—Digital Fourier Transform spread OFDM; DL—Downlink; DMRS—Demodulation Reference Signal; FB—Feed Back; FDD—Frequency Division Duplexing; FDM—Frequency Division Multiplexing; LBT—Listen-Before-Talk; LLC—Low Latency Communications; LTE Long Term Evolution e.g. from 3GPP LTE R 8 and up; MAC—Medium Access Control; NACK—Negative ACK; MBB—Massive Broadband Communications; MC—MultiCarrier; MCS—Modulation and Coding Scheme; OFDM—Orthogonal Frequency-Division Multiplexing; OOB—Out-Of-Band (emissions); Pcmax—Total available UE power in a given TI; PC5-S—PC5 signaling; PDB—Packet Delay Budget; PHY—Physical Layer; PSCCH—Physical SL Control Channel; PSFCH—Physical SL Feedback Channel; PSS—Primary Synchronization Signal; PSSCH—Physical SL Shared Channel; PSSCH-RSRP—PSSCH Reference Signal Received Power; QoS—Quality of Service (from the physical layer perspective); RNTI—Radio Network Identifier; RRC—Radio Resource Control; RRM—Radio Resource Management; RS—Reference Signal; RSRP—Reference Signal Receive Power; RSRQ—Reference Signal Receive Quality; RTT—Round-Trip Time; S-RSSI—SL Received Signal Strength Indicator; SL—Side Link; SL-RSRP—Sidelink Reference Signal Receive Power; SD-RSRP—Sidelink Discovery Reference Signal Receive Power; SS—Synchronization Signal; SSS—Secondary Synchronization Signal; TB—Transport Block; TDD—Time-Division Duplexing; TDM—Time-Division Multiplexing; TTI—Transmission Time Interval; TRP—Transmission/Reception Point; TRX—Transceiver; U2N—UE-to-Network; U2U—UE-to-UE; UL—Uplink; URLLC—Ultra-Reliable and Low Latency Communications; V2X—Vehicular communications.

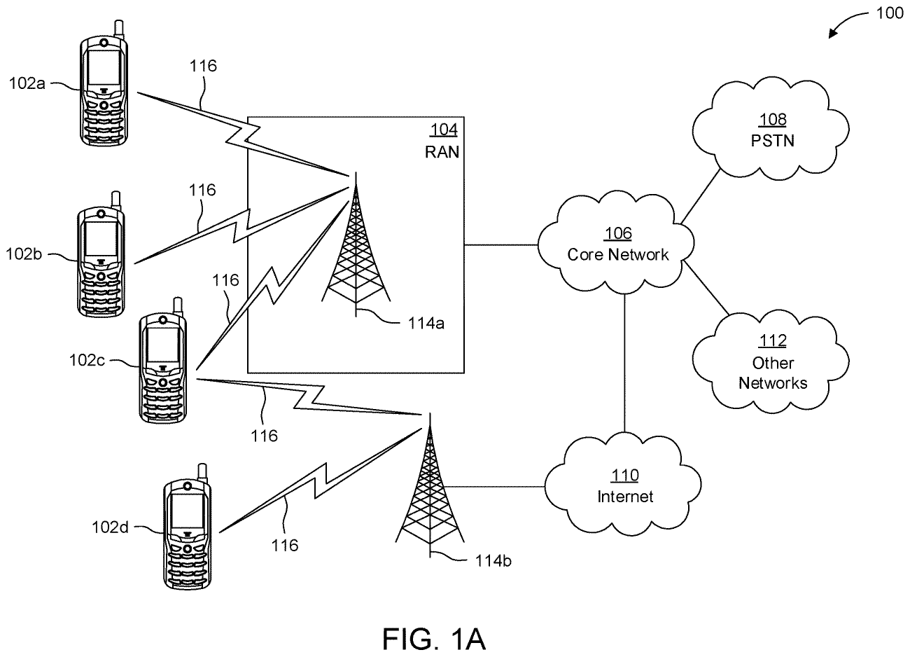

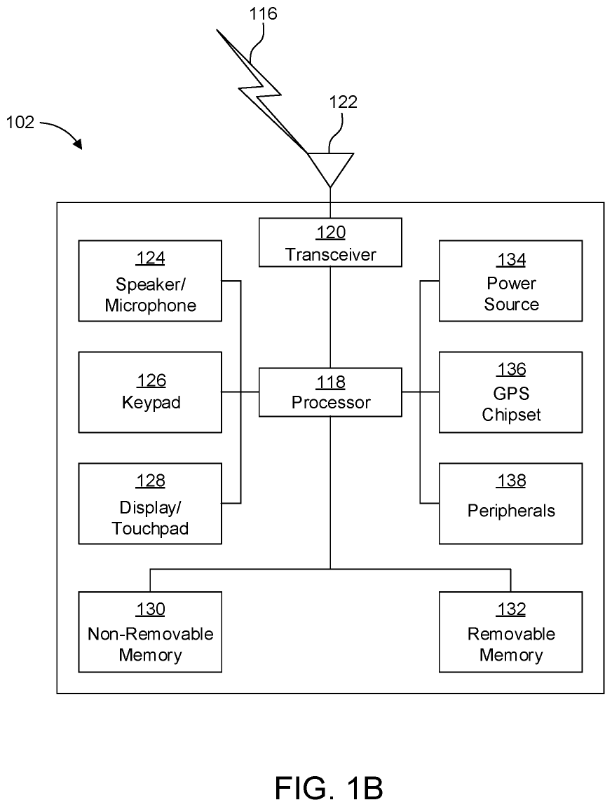

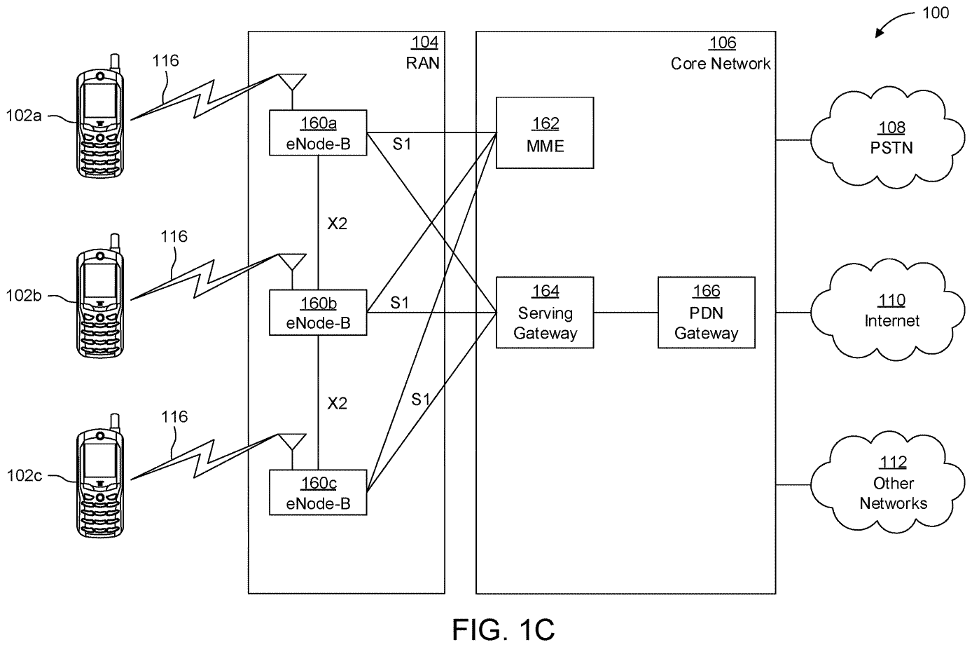

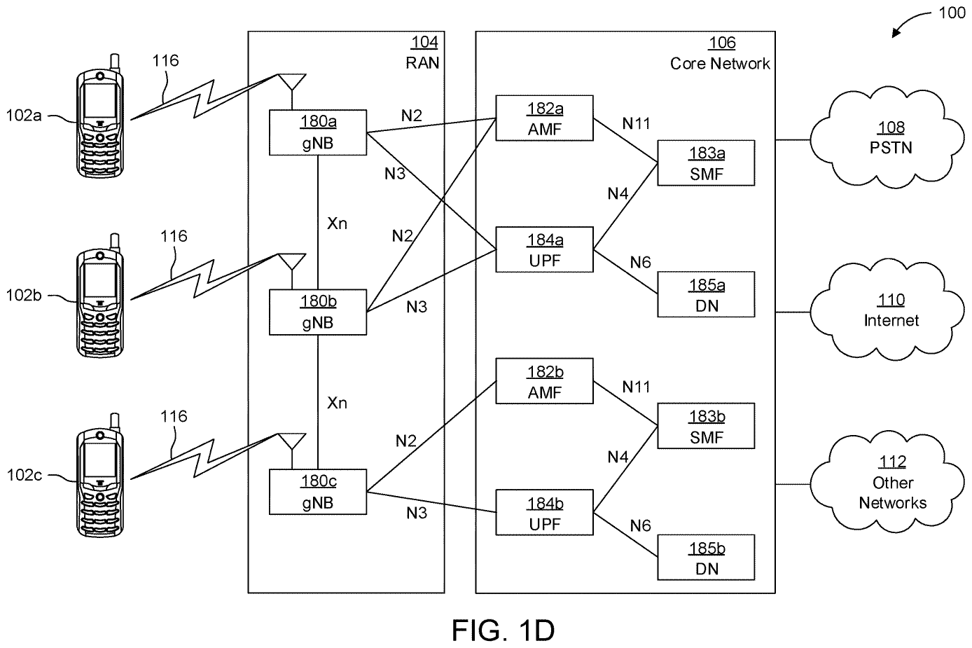

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane fucntion for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

Generally, any network side device/node/function/base station, in FIGS. 1A-1D, and/or described anywhere herein, may be interchangeable, and reference to the network may refer to a specific entity on the network side (e.g., in a communication between a WTRU and a network entity, such as a base station), as disclosed herein, such as a device, node, function, base station, cloud, or the like.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

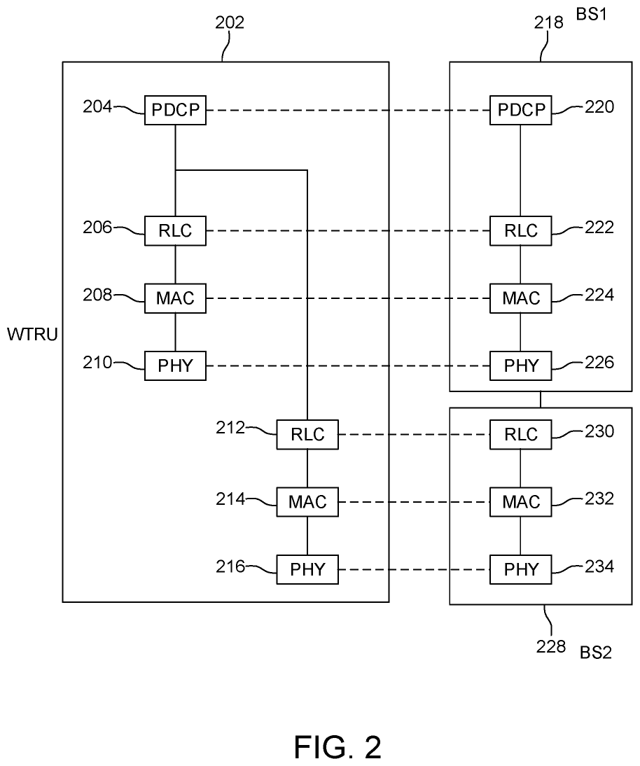

FIG. 2 illustrates an example of a protocol perspective of split bearers.

In Dual Connectivity (DC), a WTRU 202 is being served by two nodes (e.g., master node and secondary node) each comprising a set of cells, known as the Master Cell Group (MCG) and Secondary Cell Group (SCG). A bearer can be associated only with the MCG or SCG, or it can be configured to be a split bearer. FIG. 2 demonstrates the protocol view of a split bearer. As shown, the WTRU 202 may have a reciprocal layer for each layer at each base station. For example, RLC 206 of the WTRU 202 would connect with RLC 222 of BS1, MAC 208 of the WTRU 202 would connect with MAC 224 of BS1, PHY 210 of the WTRU 202 would connect with PHY 226 of BS 1, RLC 212 of the WTRU 202 would connect with RLC 230 of BS2, MAC 214 of the WTRU 202 would connect with MAC 232 of BS2, and PHY 216 of the WTRU 202 would connect with PHY 234 of BS2.

Like any bearer, the WTRU may have one PDCP entity associated with it (PDCP 204), and the peer PDCP entity on the network side may be terminated either at one of the base stations (e.g., either the master or the secondary, in FIG. 2 it is PDCP 220). In the DL, the CN may send data to the base station where the PDCP is terminated (e.g., BS1 in FIG. 2), and it may be up to the network to directly send the data to the WTRU via the link between that BS and the WTRU, or forward the PDCP PDUs to BS2 (e.g., via a link between the base stations, such as an Xn interface), and the BS may send the data to the WTRU via the link between itself and the WTRU. In one instance, the base stations are gNBs.

In the UL, the WTRU may be configured with one of the paths as the primary path, and the other as a secondary path. A threshold, known as UL split buffer threshold may also be configured. If the UL buffer size for that bearer is less this threshold, the PDCP 204 may push the data only to the RLC (e.g., 206) associated with the primary path. However, if the buffer size becomes larger than the threshold, then the WTRU may push the data to either path (e.g., which is determined by the WTRU).

In some wireless systems, there may be sidelink (SL) based WTRU to network relays. Sidelink may support 5G ProSe WTRU-to-Network Relay (U 2N Relay) function(s) to provide connectivity to the network for U2N Remote WTRU(s). Both L2 and L3 U2N Relay architectures may be supported. The L3 U2N Relay architecture is transparent to the serving RAN of the U2N Relay WTRU, except for controlling sidelink resources.

A U2N Relay WTRU may be in RRC_CONNECTED to perform relaying of unicast data.

For L2 U2N Relay operation, the following RRC state combinations may be supported: Both U2N Relay WTRU and U2N Remote WTRU may be in RRC CONNECTED to perform transmission/reception of relayed unicast data; and the U2N Relay WTRU may be in RRC_IDLE, RRC_INACTIVE or RRC_CONNECTED as long as all the U2N Remote WTRU(s) that are connected to the U2N Relay WTRU are either in RRC_INACTIVE or in RRC_IDLE.

For L2 U2N Relay, the U2N Remote WTRU may only be configured to use resource allocation mode 2 for data to be relayed.

A single unicast link may be established between one L2 U2N Relay WTRU and one L2 U2N Remote WTRU. The traffic of U2N Remote WTRU via a given U2N Relay WTRU and the traffic of the U2N Relay WTRU may be separated in different Uu RLC channels over Uu.

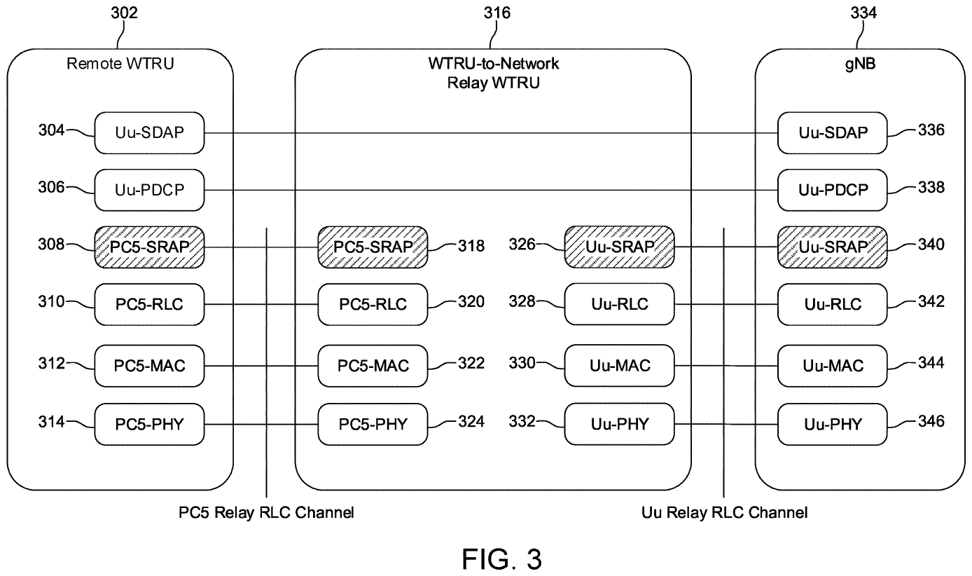

FIG. 3 illustrates an example of a user plane (UP) protocol stack for an L2 WTRU-to-Network relay. As shown, there is a remote WTRU 302, a WTRU-to-Network Relay WTRU 316, and a base station (e.g., gNB) 334. The protocol stack of the Remote WTRU 302 comprises Uu-SDAP 304, Uu-PDCP 306, PC5-SRAP 308, PC5-RLC 310, PC5-MAC 312, PC5-PHY 314. The protocol stack for the relay WTRU 316 comprises PC5-SRAP 318, PC5-RLC 320, PC5-MAC 322, PC5-PHY 320, Uu-SRAP 326, Uu-RLC 328, Uu-MAC 330, Uu-PHY 332. In one instance, PC5-SRAP 318 and Uu-SRAP 326 may be the same entity. The base station 334 protocol stack layer comprises of Uu-SDAP 336, Uu-PDCP 338, Uu-SRAP 340, Uu-RLC 342, Uu-MAC 344, Uu-PHY 346. In between the Remote WTRU 302 and the Relay WTRU 316 is the PC5 Relay RLC channel, and in between the Relay WTRU 316 and base station 334 is the Uu Relay RLC channel.

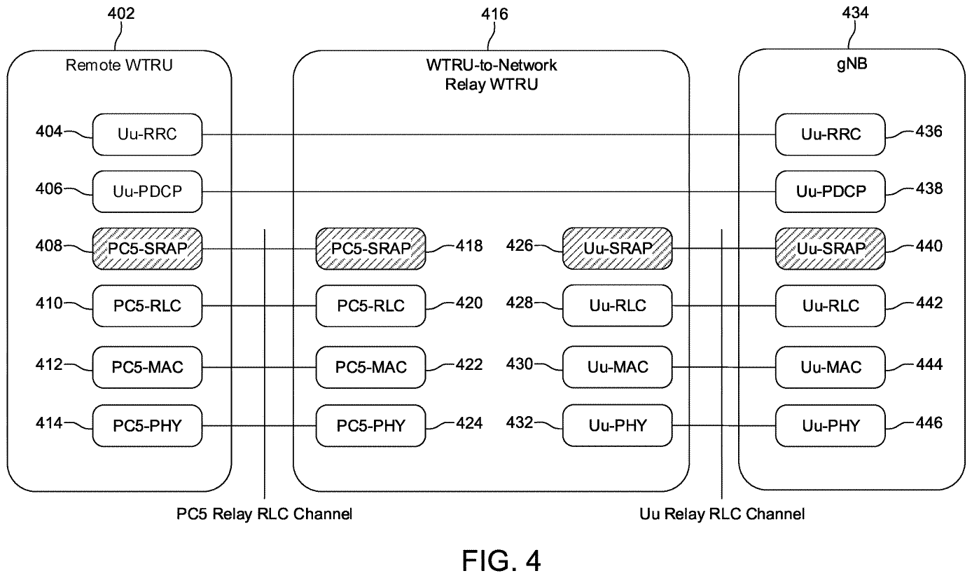

FIG. 4 illustrates an example of a control plane (CP) protocol stack for an L2 WTRU-to-Network relay. As shown, there is a remote WTRU 402, a WTRU-to-Network Relay WTRU 416, and a base station (e.g., gNB) 434. The protocol stack of the Remote WTRU 402 comprises Uu-SDAP 404, Uu-PDCP 406, PC5-SRAP 408, PC5-RLC 410, PC5-MAC 412, PC5-PHY 414. The protocol stack for the relay WTRU 416 comprises PC5-SRAP 418, PC5-RLC 420, PC5-MAC 422, PC5-PHY 420, Uu-SRAP 426, Uu-RLC 428, Uu-MAC 430, Uu-PHY 432. In one instance, PC5-SRAP 418 and Uu-SRAP 426 may be the same entity. The base station 434 protocol stack layer comprises of Uu-SDAP 436, Uu-PDCP 438, Uu-SRAP 440, Uu-RLC 442, Uu-MAC 444, Uu-PHY 446. In between the Remote WTRU 402 and the Relay WTRU 416 is the PC5 Relay RLC channel, and in between the Relay WTRU 416 and base station 434 is the Uu Relay RLC channel.

The protocol stacks for the user plane and control plane of the L2 U2N Relay architecture are presented in FIG. 3 and FIG. 4. The Sidelink Relay Adaption Protocol (SRAP) sublayer may be placed above the RLC sublayer for both CP and UP at both the PC5 interface and Uu interface. The Uu SDAP, PDCP, and RRC may be terminated between L2 U2N Remote WTRU and base station, while SRAP, RLC, MAC, and PHY may be terminated in each hop (e.g., the link between L2 U2N Remote WTRU and L2 U2N Relay WTRU and the link between L2 U2N Relay WTRU and the base station).

For L2 U2N Relay, the SRAP sublayer over PC5 hop may only be for the purpose of bearer mapping. The SRAP sublayer may not be present over PC5 hop for relaying the L2 U2N Remote WTRU's message on BCCH and PCCH. For L2 U2N Remote WTRU's message on SRB0, the SRAP sublayer may not be present over PC5 hop, but the SRAP sublayer may be present over Uu hop for both DL and UL.

For L2 U2N Relay, for uplink, the Uu SRAP sublayer may support UL bearer mapping between ingress PC5 Relay RLC channels for relaying and egress Uu Relay RLC channels over the L2 U2N Relay WTRU Uu interface. For uplink relaying traffic, the different end-to-end RBs (SRBs or DRBs) of the same Remote WTRU and/or different Remote WTRUs may be multiplexed over the same Uu Relay RLC channel.

For L2 U2N Relay, for uplink, the Uu SRAP sublayer may support L2 U2N Remote WTRU identification for the UL traffic. The identity information of L2 U2N Remote WTRU Uu Radio Bearer and a local Remote WTRU ID may be included in the Uu SRAP header at UL in order for the base station to correlate the received packets for the specific PDCP entity associated with the right Uu Radio Bearer of a Remote WTRU.

For L2 U2N Relay, for uplink, the PC5 SRAP sublayer at the L2 U2N Remote WTRU may support UL bearer mapping between Remote WTRU Uu Radio Bearers and egress PC5 Relay RLC channels.

For L2 U2N Relay, for downlink, the Uu SRAP sublayer may support DL bearer mapping at the base station to map end-to-end Radio Bearer (SRB, DRB) of Remote WTRU into Uu Relay RLC channel over Relay WTRU Uu interface. The Uu SRAP sublayer may support DL bearer mapping and data multiplexing between multiple end-to-end Radio Bearers (SRBs or DRBs) of a L2 U2N Remote WTRU and/or different L2 U2N Remote WTRUs and one Uu Relay RLC channel over the Relay WTRU Uu interface.

For L2 U2N Relay, for downlink, the Uu SRAP sublayer may support Remote WTRU identification for DL traffic. The identity information of the Remote WTRU Uu Radio Bearer and a local Remote WTRU ID may be included in the Uu SRAP header by the base station at DL in order for the Relay WTRU to map the received packets from the Remote WTRU Uu Radio Bearer to its associated PC5 Relay RLC channel.

For L2 U2N Relay, for downlink, the PC5 SRAP sublayer at the Relay WTRU may support DL bearer mapping between ingress Uu Relay RLC channels and egress PC5 Relay RLC channels.

For L2 U2N Relay, for downlink, the PC5 SRAP sublayer at the Remote WTRU may correlate the received packets for the specific PDCP entity associated with the right Uu Radio Bearer of a Remote WTRU based on the identity information included in the Uu SRAP header.

A local Remote WTRU ID may be included in both the PC5 SRAP header and the Uu SRAP header. L2 U2N Relay WTRU may be configured by the base station with the local Remote WTRU ID to be used in SRAP header. The Remote WTRU may obtain the local Remote ID from the base station via Uu RRC messages including RRCSetup, RRCReconfiguration, RRCResume and RRCReestablishment. Uu DRB(s) and Uu SRB(s) may be mapped to different PC5 Relay RLC channels and Uu Relay RLC channels in both PC5 hop and Uu hop. In some instances, it may be the base station's responsibility to avoid collision on the usage of a local Remote WTRU ID. The base station may update the local Remote WTRU ID by sending the updated local Remote ID via RRCReconfiguration message to the Relay WTRU. The serving base station may perform local Remote WTRU ID update independent of the PC5 unicast link L2 ID update procedure.

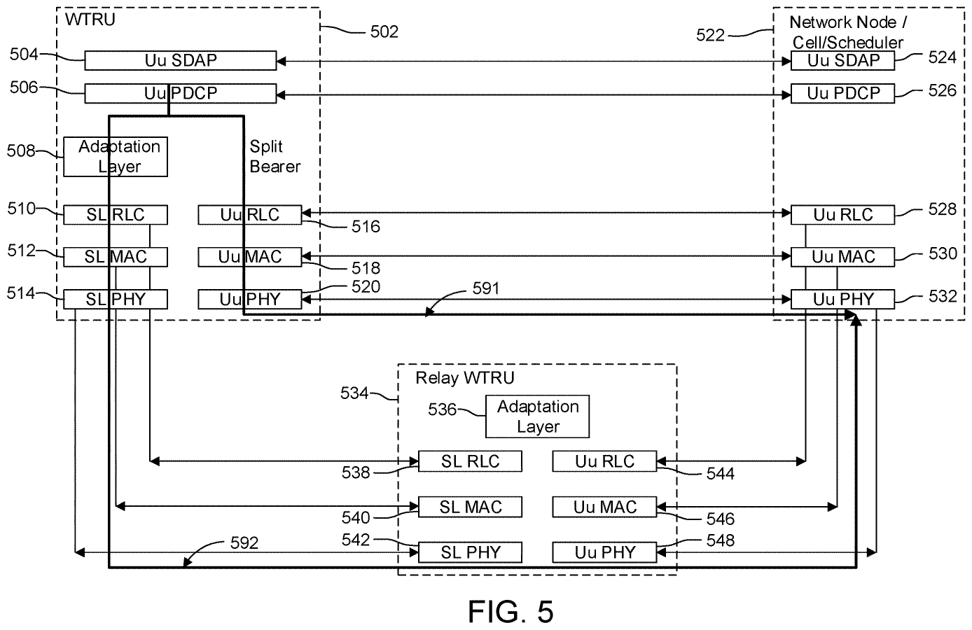

FIG. 5 illustrates an example of a multipath scenario ending at the same location. As shown, the WTRU 502 (e.g., Remote WTRU) has a split bearer (e.g., path 591 and 592), where path 592 (e.g., sidelink) goes through a relay WTRU 534 to the network node 522 (e.g., base station, cell, scheduler, or any other network node disclosed herein), and the other path 591 is a Uu connection to the network node 522. The WTRU 502 (e.g., remote WTRU) protocol stack comprises Uu-SDAP 504, Uu-PDCP 506, Adaption Layer 508, Uu-RLC 510, Uu-MAC 512, Uu-PHY 514, Uu-RLC 516, Uu-MAC 518, Uu-PHY 520. The relay WTRU 534 has a protocol stack comprising of Adaption Layer 536, SL-RLC 538, SL-MAC 540, SL-PHY 542, Uu-RLC 544, Uu-MAC 546, Uu-PHY 548. The network node 522 has a protocol stack comprising of Uu-SDAP 524, Uu-PDCP 526, Uu-RLC 528, Uu-MAC 530, Uu-PHY 532.

The paths (591 and 592) utilize ingress/egress points of the same layer for a reciprocal entity as shown; meaning that a path may traverse the same layer and link type from its egress to its ingress. For example, for path 592, the WTRU 501 may have output at SL-RLC 510 which goes to the Relay WTRU 534 at SL RLC 538 (e.g., same layer RLC, and same link type of sidelink), which in turn would be relayed utilizing the appropriate Uu connection between the Relay WTRU 532 and the network node 522 via Uu RLC 544 of WTRU 534 to Uu RLC 528 of network node 522 (e.g., again, same RLC layer and same link type of Uu). In some instances, the ingress/egress points and/or the internal links in the WTRU Relay 534 may not be 1:1, and may be X: Y, where X and Y are any positive integer. In such a case, a mapping may be utilized to facilitate the continuity of the path. In one instance, an adaption layer may facilitate the mapping process. Just as explained with regards to FIG. 3, and FIG. 4, the WTRU 502 has a layer entity for each path, as well as each layer connection (e.g., via the sidelink or the direct connection Uu). Explanations for the examples shown and described with respect to FIG. 3 and FIG. 4 may be applicable to this example of FIG. 5.

In some instances, an adaption layer may perform mapping of ingress/egress channels. In one instance, the adaption layer may help when there is an unequal mapping between a Uu and a SL for a given layer.

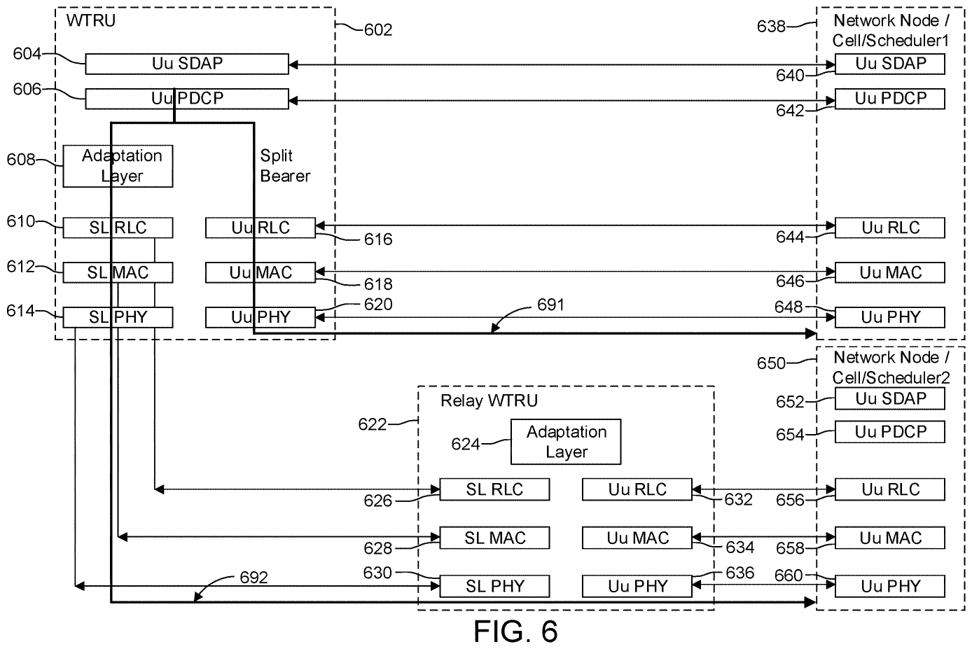

FIG. 6 illustrates an example of a multipath scenario utilizing more than one cell. As shown, the WTRU 602 (e.g., Remote WTRU) has a split bearer (e.g., path 691 and 692), where path 692 (e.g., sidelink) goes through a relay WTRU 622 to a second network node 650 (e.g., base station, Cell, Scheduler2, or any other network node disclosed herein), and the other path 691 is a Uu connection to a first network node 638 (e.g., base station, cell scheduler1, or any other network node disclosed herein). The WTRU 602 has a protocol stack that comprises Uu-SDAP 604, Uu-PDCP 606, Adaption Layer 608, SL-RLC 610, SL-MAC 612, SL-PHY 614, Uu-RLC 616, Uu-MAC 618, and Uu-PHY 620. The Relay WTRU 622 has a protocol stack that comprises adaption layer 624, SL-RLC 626, SL-MAC 628, SL-PHY 630, Uu-RLC 632, Uu-MAC 634, Uu-PHY 636. The Network Node 638 has a protocol stack that comprises Uu-SDAP 640, Uu-PDCP 642, Uu-RLC 644, Uu-MAC 646, Uu-PHY 648. The Network node 650 has a protocol stack that comprises Uu-SDAP 652, Uu-PDCP 654, Uu-RLC 656, Uu-MAC 658, Uu-PHY 660.

The paths (691 and 692) utilize ingress/egress points of the same layer for a reciprocal entity as shown; meaning that a path may traverse the same layer and link type from its egress to its ingress. For example, for path 692, the WTRU 602 may have output from SL-RLC 610 that goes to the Relay WTRU 622 at SL RLC 626 (e.g., same layer RLC, and same link type of sidelink), which in turn would be relayed utilizing the appropriate Uu connection between the Relay WTRU 622 and the network node 650 via Uu RLC 632 of WTRU 622 to Uu RLC 656 of network node 650 (e.g., again, same RLC layer and same link type of Uu). In some instances, the ingress/egress points and/or the internal links of the WTRU Relay 622 may not be 1:1, and may be X: Y, where X and Y are any positive integer. In such a case, a mapping may be utilized to facilitate the continuity of the path. In one instance, an adaption layer may facilitate the mapping process. Just as explained with regards to FIG. 2, FIG. 3, FIG. 4, and FIG. 5, the WTRU 602 has a layer entity for each path, as well as each layer connection (e.g., via the sidelink or the direct connection Uu). Explanation for the examples shown and described with respect to FIG. 2, FIG. 3, FIG. 4, and FIG. 5 and their related descriptions may be similarly applicable to this example of FIG. 6. FIG. 6 is unlike FIG. 5 and similar to FIG. 2, however, in that it is demonstrating that each path may traverse to different nodes (e.g., Network Node 638 and Network Node 650, such as a master node and a secondary node, respectively, or a node from a first cell and a node from a second cell, respectively, etc.). Just as in FIG. 2, Network Node 638 and Network Node 650 may have a connection (e.g., direct or indirect, and now shown in FIG. 6), and may be part of the same network (e.g., directly or indirectly).

For layer 2 WTRU to NW relays, a primary use case may be where a remote WTRU is out of coverage. However, this may change based on the use of multipath, where the remote WTRU is assumed to be in coverage and can therefore utilize either Uu path, SL (relayed) path, or both.

In some cases, multipath may enhance reliability and throughput (e.g., by switching among or utilizing the multiple paths simultaneously) in one or more scenarios, such as where a WTRU is connected to the same base station using one direct path and one indirect path via 1) Layer-2 WTRU-to-Network relay, or 2) via another WTRU (e.g., where the WTRU-WTRU inter-connection is assumed to be ideal), where the solutions for 1) are to be reused for 2) without precluding the possibility of excluding a part of the solutions which is unnecessary for the operation for 2.

In multipath operation, the direct link between the remote WTRU and the base station, and the backhaul link between the relay WTRU and the base station, may be served by the same base station, or even by the same cell of the same base station. If mode 1 is chosen for the scheduling of the SL between the remote WTRU and the relay WTRU, the scheduling of all the links (e.g., Uu between remote WTRU and base station, backhaul Uu between relay WTRU and base station, SL between the remote and relay WTRU) may be done by the base station. If mode2 is used and a resource pool was pre-configured by the base station for the SL that the remote WTRU can use autonomously, the base station may still be the one deciding the resource pool configuration, and thus have control over the scheduling of the SL (e.g., even though it is not as real-time as in the case of mode 1).

Multipath may be modeled similarly to DC from a protocol architecture perspective, as different MAC entities may be used for the Uu link and the SL, and the same PDCP entity may be configured for a given bearer that is using the multipath (e.g., a split bearer). However, if the same base station is serving the cells of the Uu and the SL, then one may consider this to be similar to the case of CA (carrier aggregation). However, in CA, one MAC entity is utilized, which is not really the case described in the examples herein. And to complicate things even further, the Uu and the SL maybe be served by the same cell of a given base station (e.g., not even CA).

FIG. 5 and FIG. 6 illustrate some examples on how the multipath can be may be modeled at the protocol level.

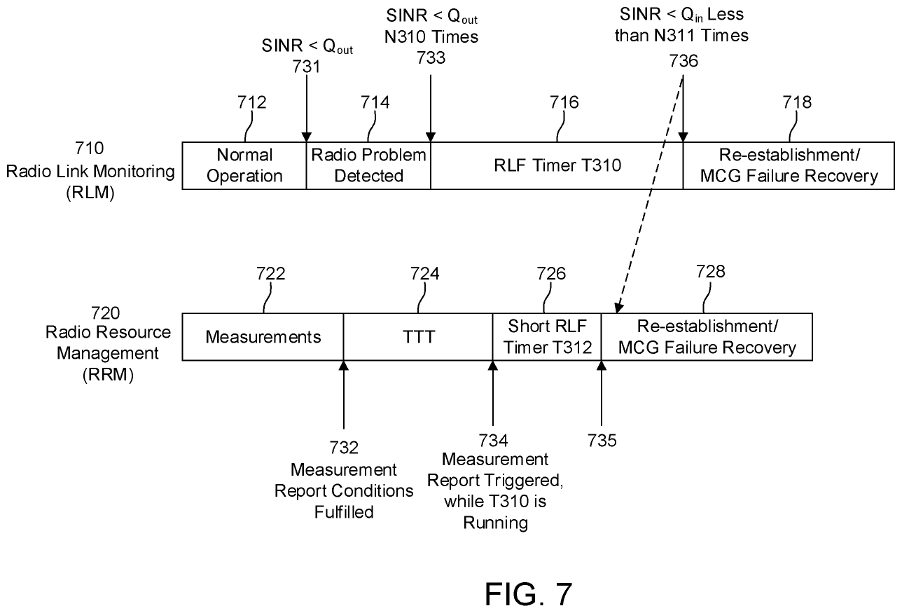

FIG. 7 illustrates an example of Radio Link Monitoring (RLM) and Radio Link Failure (RLF) detection mechanisms discussed herein.

A WTRU that is in RRC_CONNECTED needs to continuously monitor the radio link when ensuring the link is good/reliable enough for communication, a process referred to as Radio Link Monitoring (RLM). The WTRU monitors the downlink (DL) quality based on the reference signal that is being broadcasted from the serving cell.

In case the WTRU is in operating in single connectivity, the WTRU may perform RLM on the Primary Cell (PCell).

In case the WTRU is operating in dual connectivity (DC), the WTRU may perform RLM on both the PCell and the primary cell of the secondary cell group (SCG), which is referred to as PSCell.

The WTRU may be configured with which RLM reference signals (RLM-RS) to monitor in order to determine the radio quality of the PCell (e.g., and the PSCell, in case of DC). The network may configure the WTRU to perform the RLM based on SSB (Synchronization Signal Block), CSI-RS (Channel State Information Reference Signal), or a combination of the two.

WTRUs may be configured with thresholds to determine whether the radio link being monitored is good/reliable enough, such as: Qₒᵤₜ, which is the level at which the DL cannot be reliably received and shall correspond to out-of-sync block error rate (BLERout) which is the 10% block error rate of a hypothetical PDCCH transmission; and/or, Qᵢₙ, which is the level at which the DL can be significantly more reliably received than at Qₒᵤₜ and shall correspond to in-sync block error rate (BLERin), which is 2% block error rate of a hypothetical PDCCH transmission.

The WTRU may also be configured with timers and counters that are used to determine the reliability of the link being monitored, such as: N310, which is the number of consecutive times that an out-of-sync indication is received at the RRC from the lower layers (e.g., PHY) before RRC starts considering the link being monitored as experiencing reliability problem; N311, which is the number of consecutive times that an in-sync indication is received at the RRC from the lower layers (e.g., PHY) before RRC considers the link being monitored has become reliable again; and/or T310, which is the duration of the timer that is started upon N310consecutive out-of-sync indications received from lower layers, and stopped upon N311 consecutive in-sync indications.

If the T310 timer expires before the reception of N311 consecutive in-sync indications from lower layers, RRC may consider the link has failed and declares an RLF (Radio Link Failure). The WTRU may attempt to reestablish the link, recover the link, or find a new link. The specific details of how to handle the link failure are discussed further herein, and may depend on whether the WTRU is using multipath or not.

In some instances, the WTRU may employ (e.g., and be configured with) another timer (T312) to detect RLF, which is associated with measurement reporting, as part of a radio resource management (RRM) process (e.g., where measurements are taken by the WTRU and reported to the base station). This RRM process would happen concurrently with the RLM process. In one instance, a measurement reporting configuration may be associated with T312. For the RRM process, the WTRU may take measurements of the radio conditions (e.g., such as those metrics described herein). If the radio conditions have met a threshold or condition, the WTRU may report the measurements. In some instances, there may be a Time to Trigger (TTT) where the WTRU must experience the measurement condition for a certain period of time prior to triggering the reporting. Once the reporting conditions are fulfilled and a measurement report is to be sent, and if this measurement reporting configuration has been associated with T312, the WTRU may check if the T310 is already running (e.g., determine whether the RLM process has already identified a problem and waiting for the recovery). If so, the WTRU may start the T312 timer, with the duration set to the configured T312, and if the problem is not resolved before the timer expires, then the WTRU may declare an RLF based on the RRM process. Explained another way, T312 may be used to detect a late HO (e.g., had the measurement reporting been sent earlier than the radio link problem started, the WTRU may have been handed over to a target cell in time).

FIG. 7 illustrates an example of the RLM and RLF detection mechanisms discussed herein. As shown, there is a radio link monitoring (RLM) 710 process running concurrently with a radio resource management (RRM) 720 process. Time is illustrated approximately in the horizontal axis with respect to the two processes. The two processes are running with respect to one WTRU connected to the network. This approach of FIG. 7 may help determine whether the WTRU is in a coverage hole or the WTRU is at the edge of coverage (e.g., in the event that there was an error in the configuration of the proper thresholds for the WTRU). The example shown may be applicable to both multipath and non-multipath scenarios (e.g., one radio link may be discussed, however, it is intended that the same/similar process as described with respect to the example of FIG. 7 is applicable to multiple link scenarios, such as described herein with regard to relays, etc.).

As shown, at 712 radio link monitoring may be performed in the RLM 710 process, wherein the WTRU monitors the DL quality based on one or more reference signals being broadcasted by the serving cell (e.g., one or more). At 731, the WTRU may take a measurement(s) that does not meet a relevant threshold related to the monitored signal, such as the SINR is detected as being less than Qₒᵤₜ, at which point a radio problem may be detected at 714 by the WTRU. At 733, the WTRU may determine that the radio problem has been detected at least a threshold number of times, such as N310 times, at which point at 716 the WTRU may begin a RLF timer (e.g., T310). At the end of the timer T310 at 736, if the radio conditions do not improve by a threshold (e.g., if the SINR is less than Qᵢₙ less than N311 times), then at 718 the WTRU may determine that the link has failed (e.g., this could occur for one or more links), and a link may need to be reestablished, recovered, or a new link must be found. Concurrently, an RRM process 720 may be operating, which involves taking measurements at 722. At 732, a measurement reporting condition may be met, and the WTRU uses TTT at 724 to determine if/when to report. At 734, the measurement report is triggered, and the report should/is sent. This may occur while RLF timer T310 is running, in which case a short RLF timer T312 may be used at 726. Rather than the WTRU waiting until the RLF timer T310 expires, the WTRU may now know sooner that RLF has occurred based on the expiration of T312 at 735, at which point the link is known to have failed, and a process at 728 (e.g., similar to 718) may begin to reestablish the link, recover the link, or start a new link.

In one case, a RLF detection process (e.g., example of FIG. 7) may be applied to a multi-link scenario, based on one more techniques described herein. A WTRU may be configured with the requisite timers, counters, and thresholds in order to carry out the process. The configuration may be sent in one or more messages, and one or more pieces of the information may be preconfigured. There may be sets of parameters associated with specific conditions that may depend on one of the links in a multi-link scenario (e.g., as described further herein). For example, if one link meets one or more thresholds, then another link may be assessed as well. The ability to condition the assessment can reduce overhead and unnecessary processing (e.g., this in turn can help battery life). The ability to trigger the assessment of other links makes the WTRU and overall process more efficient by potentially reducing the time before a failure assessment of a given link may have otherwise occurred.

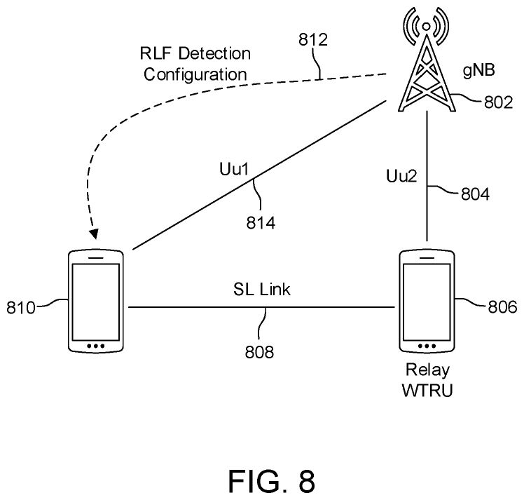

FIG. 8 illustrates an example of a radio link failure in a WTRU relay scenario. As shown, there may be a remote WTRU 810 that has a sidelink link 808 to a relay WTRU 806, which in turn has a Uu link 804 to a base station 802 (e.g., gNB). The Remote WTRU 810 also has a direct Uu link 814 to the base station 802. At some point, the Remote WTRU 810 may receive RLF detection configuration from the base station 802. The example shown in FIG. 8 may be have similarities to other examples provided herein, and it is intended that related descriptions and figures are equally applicable. For example, such a scenario as shown in FIG. 8 may be similar to descriptions related to FIG. 3, FIG. 4, FIG. 5, and FIG. 7. Further, such a scenario may undergo a RLF detection process, as described herein.

In some cases (e.g., in addition or in the alternative to the example of FIG. 7), there may be other scenarios where the Uu RRC declares RLF, such as: upon random access problem indication from MAC (e.g., when a WTRU does not receive a random-access response (RAR) after sending a random-access preamble to the network a certain number of times); upon an indication from RLC that the maximum number of retransmissions has been reached; if connected as an Integrated Access Backhaul (IAB)-node, upon Back Haul (BH) RLF indication received on BackHaul Adaptation Protocol (BAP) entity (e.g., the link between the IAB node and the network has failed); and/or, upon consistent uplink LBT (listen before talk) failure indication from MAC when operating in unlicensed mode.

If radio link failure is detected for a MCG, and fast MCG link recovery is configured, the WTRU may trigger fast MCG link recovery. Otherwise, the WTRU may initiate a RRC connection re-establishment procedure. During fast MCG link recovery, the WTRU may suspend MCG transmissions for all radio bearers and report the failure with MCG Failure Information message to the MN via the SCG, using the SCG leg of a split SRB1 or SRB3.

The WTRU may include in the MCG Failure Information message the measurement results available according to current measurement configuration of both the MN and the SN. Once the fast MCG link recovery is triggered, the WTRU may maintain the current measurement configurations from both the MN and the SN, and continues measurements based on configuration from the MN and the SN, if possible. The WTRU may initiate the RRC connection re-establishment procedure if it does not receive an RRC reconfiguration message, MobilityFromNRCommand message, MobilityFromEUTRACommand message or RRC release message within a certain time after fast MCG link recovery was initiated.

Upon receiving an RRC reconfiguration message, MobilityFromNRCommand message or MobilityFromEUTRACommand message, the WTRU may resume MCG transmissions for all radio bearers. Upon receiving an RRC release message, the WTRU may release all the radio bearers and configurations.

Upon SCG failure, if MCG transmissions of radio bearers are not suspended, the WTRU may suspend SCG transmissions for all radio bearers and reports the SCG Failure Information to the MN, instead of triggering re-establishment. If SCG failure is detected while MCG transmissions for all radio bearers are suspended, the WTRU may initiate the RRC connection re-establishment procedure.

In all SCG failure cases, the WTRU may maintain the current measurement configurations from both the MN and the SN and the WTRU continues measurements based on configuration from the MN and the SN if possible.

The WTRU may include in the SCG Failure Information message the measurement results available according to current measurement configuration of both the MN and the SN.

In the above, and in other situations disclosed herein, re-establishment may comprise of a procedure whereby the WTRU performs cell selection, and the WTRU transmits a re-establishment request RRC message upon selection of a cell.

A remote WTRU may perform RLM on a SL based on the HARQ feedback to UL data transmission. Specifically, the SL MAC entity may be configured to monitor the number of consecutive SL-HARQ Discontinuous Transmission (DTX) indications from the lower layer (e.g., SL PHY layer), and when this reaches a certain pre-configured value, the WTRU may consider a SL RLF is detected.

The RRC may configure the following parameter to control HARQ-based SL RLF detection: s/-maxNumConsecutiveDTX.

The following WTRU variable may be used for HARQ-based SL RLF detection: numConsecutiveDTX, which is maintained for each PC5-RRC connection.

The Sidelink HARQ Entity may (re-)initialize numConsecutiveDTX to zero for each PC5-RRC connection which has been established by upper layers, if any, upon establishment of the PC5-RRC connection or (re)configuration of sl-maxNumConsecutiveDTX.

The Sidelink HARQ Entity may, for each physical sidelink feedback channel (PSFCH) reception occasion associated to the physical sidelink shared channel (PSSCH) transmission, if PSFCH reception is absent on the PSFCH reception occasion (e.g., no HARQ feedback received for a SL UL transmission), increment numConsecutiveDTX by 1. If numConsecutiveDTX reaches s/-maxNumConsecutiveDTX, then the entity may indicate HARQ-based Sidelink RLF detection to RRC. Otherwise (e.g., no reason to increment numConsecutiveDTX), the entity may re-initialize numConsecutiveDTX to zero.

In addition to RLF based on HARQ DTX, the remote WTRU may also consider an RLF has been detected on the SL when: upon indication from sidelink RLC entity that the maximum number of retransmissions for a specific destination has been reached; upon T400 expiry for a specific destination (e.g., T400 is started upon the transmission of a SL RRC Reconfiguration message, and if the timer expires before the reception of a SL RRC reconfiguration complete message or SL RRC Reconfiguration failure message); upon integrity check failure indication from sidelink PDCP entity concerning SL-SRB2 or SL-SRB3 for a specific destination; and/or, upon the reception of an RLF of the backhaul Uu between the relay WTRU and the base station.

A remote WTRU that is connected in a multipath fashion via a Uu link and SL (e.g., via a relay WTRU) may be controlled by the same base station. The Uu and SL may be even served by the same cell of the base station. Thus, considering RLF detection on these two links completely independently may lead to suboptimal behavior. For example, the Uu RLF timers and counters may be configured under the assumption that there is no alternative path like the multipath for that same link. As such, even if the SL conditions are very good (e.g., a link with the base station can still be maintained), the WTRU may end up declaring a Uu RLF. Similarly, the SL max HARQ DTX may be configured under the assumption that there is no alternative path towards the base station. As such, even if the Uu is in very good condition, the WTRU may declare SL RLF just based on the configured max HARQ DTX. This issue may be addressed by one or more approaches/techniques/examples as described herein.

In one scenario, a remote WTRU in multipath is where a WTRU is connected to the network via two different paths-a direct Uu path and a path via a SL WTRU to NW relay. The connection via the two paths may be to the same base station/scheduler (e.g., the remote WTRU and the relay WTRU are under the control of the same base station or even under the same cell) or to different base station/schedulers (e.g., the remote WTRU and the relay WTRU are under the control of different base stations). Generally, one or more techniques and/or approaches may be discussed in the context of this scenario, however, the approaches and techniques discussed herein are equally applicable to multiple paths (more than one), or to the case where more than one path via SL WTRU to NW relay WTRUs are maintained by the remote WTRU.

As discussed herein, the number of OOS, IS, HARQ DTX, HARQ feedback, etc. may be counted if they happen consecutively or non-consecutively. For example, the WTRU may stop counting the current number of OOS to zero upon the reception of the first IS indication. In another example, the WTRU may keep incrementing the number of OOS, even after some IS indications are received, until the number of consecutive IS indications are received to stop the T310 that was started when the OOS passed a certain limit.

In some cases, there may be one or more methods for RLF detection on one path that is dependent on the other path. In one situation, a remote WTRU in multipath may determine the Uu RLF timers and constants based on SL radio conditions. The remote WTRU may be configured with multiple sets of Uu RLF timers and counter values (e.g., set1: {t310=t1, n310=na_1, n311=nb_1}, set2: {{310=t2, n310=nb_1, n311=nb_2}, etc.,), where each set is associated with a certain value or range of values of the SL RSRP/RSRQ. For example, the WTRU may be configured to use set1 if the SL RSRP/RSRQ is below threshold1, use set2 if SL RSRP/RSRQ is between threshold1 and threshol2, use set3 if SL RSRP/RSRQ is between threshold2 and threshold 3, use set4 if the SL RSRP/RSRQ is above threshold3, and the like.

In one case, the t310, n310 and n311 values to be used for different values or range of values of the SL RSRP may be configured independently. For example, t310_1 is for RSRP range 1, t310_2 for RSRP range 2, t310_3 for RSRP range 3, etc. ; n310_a is for RSRP range a, n310_b for RSRP range b, etc; and/or, n311_x is for RSRP range x, n311_y for RSRP range y, etc.

In one case, the remote WTRU may be configured with a baseline RLF timer value (e.g., baseline_t310) and a scaling factor/function that is to be applied on this value depending on the current SL RSRP/RSRQ as compared to a baseline SL RSRP/RSRQ threshold. For example, the WTRU may apply the baseline_t310 value when SL RSRP is below threshold_1, scale the t310 up or down (e.g., based on configuration) by a certain factor when the RSRP is above threshold_1 (e.g., if SL RSRP is rsrp_current, then t310 will be updated to t310*scaling factor*rsrp_current/threshold_1). Instead of a multiplication factor, an offset value may be added or subtracted (e.g., depending on configuration) to the baseline t310 value (e.g., t310 will be updated to baseline_t310+delta*rsrp_current/threshold_1).

In one case, the remote WTRU may be configured with a baseline n310 value (e.g., baseline_n310) and a scaling factor/function that is to be applied on this value depending on the current SL RSRP/RSRQ as compared to a baseline SL RSRP/RSRQ threshold. For example, the WTRU may use the baseline_n310 value when SL RSRP is below threshold_1, scale the n310 up or down (e.g., based on configuration) by a certain factor when the RSRP is above threshold_1 (e.g., if SL RSRP is rsrp_current, then n310 will be updated to n310*scaling factor*rsrp_current/threshold_1). Instead of a multiplication factor, an offset value may be added or subtracted (e.g., depending on configuration) to the baseline n310 value (e.g., n310 will be updated to baseline_n310 +delta*rsrp_current/threshold_1).

In one case, the remote WTRU may be configured with a baseline n311 value (e.g., baseline_n311) and a scaling factor/function that is to be applied on this value depending on the current SL RSRP/RSRQ as compared to a baseline SL RSRP/RSRQ threshold. For example, the WTRU may use the baseline_n310 value when SL RSRP is below threshold_1, scale the n311 up or down (e.g., based on configuration) by a certain factor when the RSRP is above threshold_1 (e.g., if SL RSRP is rsrp_current, then n311 will be updated to n310*scaling factor*rsrp_current/threshold_1). Instead of a multiplication factor, an offset value may be added or subtracted (e.g., depending on configuration) to the baseline n311 value (e.g., n311 will be updated to baseline_n311 +delta*rsrp_current/threshold_1).

In one situation, there may be a remote WTRU in multipath that determines the Uu RLF timers and constants based on SL CBR/CR conditions. The remote WTRU may be configured with multiple sets of Uu RLF timers and counter values (e.g., set1: {t310=t1, n310=na_1, n311=nb_1}, set2: {310=t2, n310=nb_1, n311=nb_2}, etc.,), each set associated with a certain value or range of values of the SL CBR/CR. For example, the WTRU may be configured to use set1 if the SL CBR/CR is below threshold1, use set2 if SL CBR/CR is between threshold1 and threshol2, use set3 if SL CBR/CR is between threshold2 and threshold 3, use set4 if the SL CBR/CR is above threshold3, etc.

In one case, the t310, n310 and n311 values may be used for different values or range of values of the SL CBR/CR, and may be configured independently. For example: t310_1 is for CBR/CR range 1, t310_2 for CBR/CR range 2, t310_3 for CBR/CR range 3, etc. ; n310_a is for CBR/CR range a, n310_b for CBR/CR range b, etc. ; and/or, n311_x is for CBR/CR range x, n311_y for CBR/CR range y, etc.

In one case, the remote WTRU may be configured with a baseline RLF timer value (e.g., baseline_t310) and a scaling factor/function that is to be applied on this value depending on the current SL CBR/CR as compared to a baseline SL CBR/CR threshold. For example, the WTRU may use the baseline_t310value when SL CBR/CR is below threshold_1, scale the t310 up or down (e.g., based on configuration) by a certain factor when the CBR/CR is above threshold_1 (e.g., if SL CBR is cbr_current, then t310 will be updated to baseline_t310*scaling factor*cbr_current/threshold_1). Instead of a multiplication factor, an offset value may be added or subtracted (e.g., depending on configuration) to the baseline t310 value (e.g., t310 will be updated to baseline_t310 +delta*cbr_current/threshold_1).

In one case, the remote WTRU may be configured with a baseline n310 value (e.g., baseline_n310) and a scaling factor/function that is to be applied on this value depending on the current SL CBR/CR as compared to a baseline SL CBR/CR threshold. For example, the WTRU may use the baseline_n310 value when SL CBR/CR is below threshold_1, scale the n310 up or down (e.g., based on configuration) by a certain factor when the CBR/CR is above threshold_1 (e.g., if SL CBR is cbr_current, then n310 will be updated to baseline_n310*scaling factor* cbr_current/threshold_1). Instead of a multiplication factor, an offset value may be added or subtracted (e.g., depending on configuration) to the baseline n310 value (e.g., n310 will be updated to baseline_n310 +delta*cbr_current/threshold_1).

In one case, the remote WTRU may be configured with a baseline n311 value (e.g., baseline_n311) and a scaling factor/function that is to be applied on this value depending on the current SL CBR/CR as compared to a baseline SL CBR/CR threshold. For example, the WTRU may use the baseline_n311 value when SL CBR/CR is below threshold_1, scale the n311 up or down (e.g., based on configuration) by a certain factor when the CBR/CR is above threshold_1 (e.g., if SL CBR is cbr_current, then n311 will be updated to baseline_n311*scaling factor* cbr_current/threshold_1). Instead of a multiplication factor, an offset value may be added or subtracted (e.g., depending on configuration) to the baseline n311 value (e.g., n311 will be updated to baseline_n311 +delta*cbr_current/threshold_1).

In one situation, RLF timers and constants may be changed while T310, or the like, is running. In one case the change of the RLF timers/constant values is performed only if T310 is not running.

For example, if previous t310 value was a ms, and the RLF timer/constant value change happens b ms after the T310 has started (e.g., a-b ms left before timer expiry), and the new value for the RLF timer is c ms, then the timer will expire after c-b ms, assuming n311 IS indications are not received before that happens. In the case c is less than b, the remote WTRU may consider the timer has expired already upon the change of the RLF timer value and declare an RLF.

In one case, when the RLF timer/constant values are changed from one set to another set (e.g., upon the detection of a change of the SL RSRP/RSRQ or CBR from one value/range associated with one set of RLF timer/constant values to another), the remote WTRU may be configured to stop the T310 timer (e.g., if it was running).

In one case, when the RLF timer/constant values are changed from one set to another set (e.g., upon the detection of a change of the SL RSRP/RSRQ or CBR from one value/range associated with one set of RLF timer/constant values to another), the remote WTRU may be configured to reset the current value of the n310 counter to 0 (e.g., ignore previous OOS received before the change of the RLF timers/constants).

In one case, when the RLF timer/constant values are changed from one set to another set (e.g., upon the detection of a change of the SL RSRP/RSRQ or CBR from one value/range associated with one set of RLF timer/constant values to another), the remote WTRU may be configured to keep the current value of the n310 counter (e.g., consider previous OOS received before the change of the RLF timers/constants).

In one case, when the RLF timer/constant values are changed from one set to another set (e.g., upon the detection of a change of the SL RSRP/RSRQ or CBR from one value/range associated with one set of RLF timer/constant values to another), the remote WTRU may be configured to reset the current value of the n311 counter to 0 (e.g., ignore previous IS received before the change of the RLF timers/constants).

In one case, when the RLF timer/constant values are changed from one set to another set (e.g., upon the detection of a change of the SL RSRP/RSRQ or CBR from one value/range associated with one set of RLF timer/constant values to another), the remote WTRU may be configured to keep the current value of the n311 counter (e.g., consider previous IS received before the change of the RLF timers/constants).

In one situation, a remote WTRU in multipath may determine the SL HARQ DTX counter based on Uu radio conditions. In one case, the remote WTRU may be configured with multiple values of sl-maxNumConsecutiveDTX (e.g., value 1, value 2, value 3, etc.,), each value associated with a certain value or range of values of the Uu RSRP/RSRQ. For example, the WTRU may be configured to use value 1 if the Uu RSRP/RSRQ is below threshold1, use value2 if Uu RSRP/RSRQ is between threshold1 and threshol2, use value3 if SL RSRP/RSRQ is between threshold2 and threshold 3, use value4 if the SL RSRP/RSRQ is above threshold3, etc.,

In one case, the remote WTRU may be configured with a baseline s/-maxNumConsecutiveDTX value (e.g., baseline_dtx) and a scaling factor/function that is to be applied on this value depending on the current Uu RSRP/RSRQ as compared to a baseline Uu RSRP/RSRQ threshold. For example, the WTRU may use the baseline_dtx value when Uu RSRP is below threshold_1, scale it up or down (e.g., based on configuration) by a certain factor when the Uu RSRP is above threshold_1 (e.g., if Uu RSRP is rsrp_current, then maximum HARQ DTX value to trigger SL RLF will be updated to baseline_dtx*scaling factor*rsrp_current/threshold_1). Instead of a multiplication factor, an offset value may be added or subtracted (e.g., depending on configuration) to the baseline dtx value (e.g., max DTX value will be updated to baseline_dtx +delta*rsrp_current/threshold_1).

In one case, the change of the SL RLF max HARQ DTX counter may be handled while the current DTX value is not zero. In one case, the change of the sl-maxNumConsecutiveDTX is performed only if the current value of numConsecutiveDTX is zero.

In one case, when the s/-maxNumConsecutiveDTX value is changed from one value to another (e.g., according to any of the techniques described herein), the remote WTRU may be configured to reset the numConsecutiveDTX value to zero.

In one case when the s/-maxNumConsecutiveDTX value is changed from one value to another (e.g., according to any of the techniques described herein), the remote WTRU may be configured to keep the numConsecutiveDTX value. For example, if the s/-maxNumConsecutiveDTX value was 5 and was changed to 4, and the WTRU has numConsecutiveDTX=3 (e.g., 3 consecutive DTX already detected), then SL RLF will be triggered after one additional DTX. As another example, if the s/-maxNumConsecutiveDTX value was 5 and changed to 4, and numConsecutiveDTX=4 (e.g., 4 consecutive DTX already detected), the WTRU may immediately declare SL RLF.

In an example, the update of the Uu RLF timer/constant value based on the SL RSRP/RSRQ and CBR/CR may be applied together. This could be done independently, or a combined set or scaling factor may be configured. For example, different set of values can be assigned that are associated with a given range of CBR/CR values and RSRP/RSRQ ranges.

In an example, the remote WTRU may be configured either to update the SL RLF detection parameters (e.g., s/-maxNumConsecutiveDTX) based on Uu conditions or the Uu RLF detection parameters (e.g., t310, n310, n311) based on SL conditions, but not to perform both together.

In an example, the remote WTRU may be configured to update the SL RLF detection parameters (e.g., sl-maxNumConsecutiveDTX) based on Uu conditions AND the Uu RLF detection parameters (i.e., t310, n310, n311) based on SL conditions.

In an example, upon a detection of SL RLF, the remote WTRU may also restore the Uu RLF detection parameters to a baseline value set (e.g., reset the Uu RLF counters, stop the Uu RLF timers, etc.).

In an example, upon a detection of Uu RLF, the remote WTRU may restore the SL RLF parameters/counters to a baseline value (e.g., numConsecutiveDTX set to 0).

In some cases, there may be one or more approaches for joint RLF detection of SL and Uu.

In one case, the remote WTRU may detect the RLF for the multipath based on a joint consideration of the Uu and SL (e.g., joint consideration of the Uu and RLF counters and/or timers).

In one case, the remote WTRU may be configured to consider the sum of the number of consecutive Uu OOS indications (e.g., current value of Uu n310 counter) and number of consecutive SL HARQDTX (e.g., current value of numConsecutiveDTX) to consider the multipath link is experiencing a problem. For example, the WTRU may be configured with N310=a and maxNumConsecutiveDTX=b, and configured with maxOOSandDTX=c (e.g., c <a+b). When the sum of the current Uu consecutive OOS and current consecutive HARQ DTX equal c, the WTRU may consider the multipath is experiencing a problem. The WTRU may then start a timer to wait for the condition to improve. For example, the WTRU may start timer T310 or timer T400.

In one case, the remote WTRU may be configured to consider the number of consecutive Uu OOS indications OR number of consecutive SL DTX to consider the multipath link is experiencing a problem. For example, the WTRU may be configured with N310=a and maxNumConsecutiveDTX=b, and configured with N310_multipath (e.g., with value greater than a) and maxNumConsecuriveDTX_multipath (e.g., with value greater than maxNumConsecutiveDTX). When the WTRU detects the current Uu consecutive OOS equals than N310_multipath or current consecutive HARQ DTX equals maxNumConsecuriveDTX_multipath, the WTRU may consider the multipath has experienced a failure and initiated an RLF recovery procedure (e.g., re-establishment, Uu Recovery via the SL using MCGFailure-like or SCGFailure-like procedure if the problem was on the Uu, SL Recovery via the Uu using MCGFailure-like or SCGFailure-like procedure if the problem was on the SL, etc.).

In one case, the remote WTRU may be configured to consider the sum of the number of consecutive Uu IS indications (e.g., current value of Uu n311 counter) and/or the reception of a certain number of consecutive SL HARQ feedback to consider the multipath link is not experiencing a problem anymore. For example, assume the WTRU has started the T310 based on the sum of the consecutive OOS and consecutive HARQ DTX as discussed above. In one example, the WTRU may assume that the multipath link is not experiencing a problem anymore and stop the timer T310 if it: receives a certain number of consecutive IS indications (e.g., which may be configured to be equal to, greater than or less than N311 or equal to, greater than or less than N310); receives a certain number of consecutive HARQ feedback indications (e.g., which may be configured to be equal to 1 or greater than 1); receives a certain number of consecutive HARQ feedback indications and consecutive IS indications (e.g., which may be equal, greater or less than the maxOOSandDTX that triggered the start of the T310); and/or, receives a certain number of consecutive HARQ feedback indications or consecutive IS indications.

In one case, while the T310 is running based on any of the approaches described herein, the remote WTRU may keep monitoring further OOS indications from the Uu or HARQ DTX indication from the SL, and may decide the multipath link has failed (i.e., stop T310 and initiate any RLF recovery procedure such as Re-establishment, MCG/SCG failure like recovery, Relay re-selection, etc.,) based on one or more of the following: having received a certain number of consecutive OOS indications after the start of the T310; having received a certain number of total OOS indications (e.g., not necessarily consecutive) after the start of the T310; the total number of consecutive OOS indications (e.g., before and after the start of the T310) is equal to a certain value; the total number of OOS indications (e.g., before and after the start of the T310) is equal to a certain value (i.e., not necessarily consecutive); having received a certain number of consecutive HARQ DTX indications after the start of the T310; having received a certain number of HARQ DTX indications (e.g., not necessarily consecutive) after the start of the T310; the total number of consecutive HARQ DTX indications (e.g., before and after the start of the T310) is equal to a certain value; the total number of HARQ DTX indications (e.g., before and after the start of the T310) is equal to a certain value (e.g., not necessarily consecutive); and/or, a combination of any of the above (e.g., consecutive OOS+consecutive DTX after the start of the T310 passes a certain value, total OOS or total DTX after the start of the T310 passes a certain value, etc.,).

In one case, while the T310 is running based on any of the approaches described herein, if the remote WTRU receives an indication from the relay WTRU that the backhaul Uu link of the relay WTRU has experienced a failure, it may consider the multipath has failed (e.g., stop T310 and initiate any RLF recovery procedure such as Re-establishment, MCG/SCG failure like recovery, Relay re-selection, etc.,).

In one example, a remote WTRU in multipath may determine the Uu RLF timer(s) and constraint(s) based on SL radio conditions.

In one example, a remote WTRU in multipath may determine the Uu RLF timers and constants based on SL CBR/CR conditions.

In one example, a remote WTRU in multipath may determine the SL HARQ DTX counter based on Uu radio conditions.

In one example, a remote WTRU may assess that the multipath link is experiencing a problem if the sum of the number of (e.g., consecutive) Uu OOS indications and number of (e.g., consecutive) SL HARQ DTX is above a certain configured value.

In one example, a remote WTRU may assess that the multipath link is experiencing a problem if the number of (e.g., consecutive) Uu OOS indications or number of (e.g., consecutive) SL HARQ DTX is above a certain configured value.

In one example, a remote WTRU may assess that the multipath link is not experiencing a problem if the sum of the number of (e.g., consecutive) Uu IS indications and the number of (e.g., consecutive) SL HARQ feedback is above a certain configured value.

In one example, a remote WTRU may assess that the multipath link is not experiencing a problem if the number of (e.g., consecutive) Uu IS indications or the number of (e.g., consecutive) SL HARQ feedback is above a certain configured value.

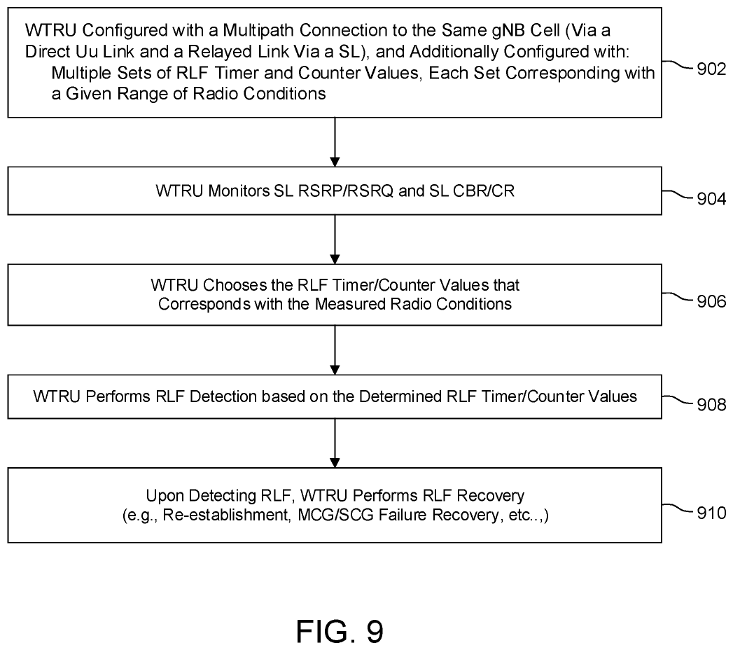

FIG. 9 illustrates an example of a RLF detection process according to one or more approaches described herein. At 902, a WTRU may be configured with a multipath connection to the same gNB cell (via a direct Uu link and a related link via a SL). The WTRU may also be configured with multiple sets of RLF timer and counter values, where each set may correspond with a given range of radio conditions (e.g., SL RSRP/RSRQ and/or SL CBR/CR). At 904, the WTRU may monitor the radio conditions. At 906, the WTRU may choose the RLF timer/counter values that correspond with the measured radio conditions. At 908 the WTRU may perform RLF detection based on the determined RLF timer/counter values. At 910, upon detecting RLF, the WTRU may perform RLF recovery (e.g., re-establishment, MCG/SCG failure recover, etc.).

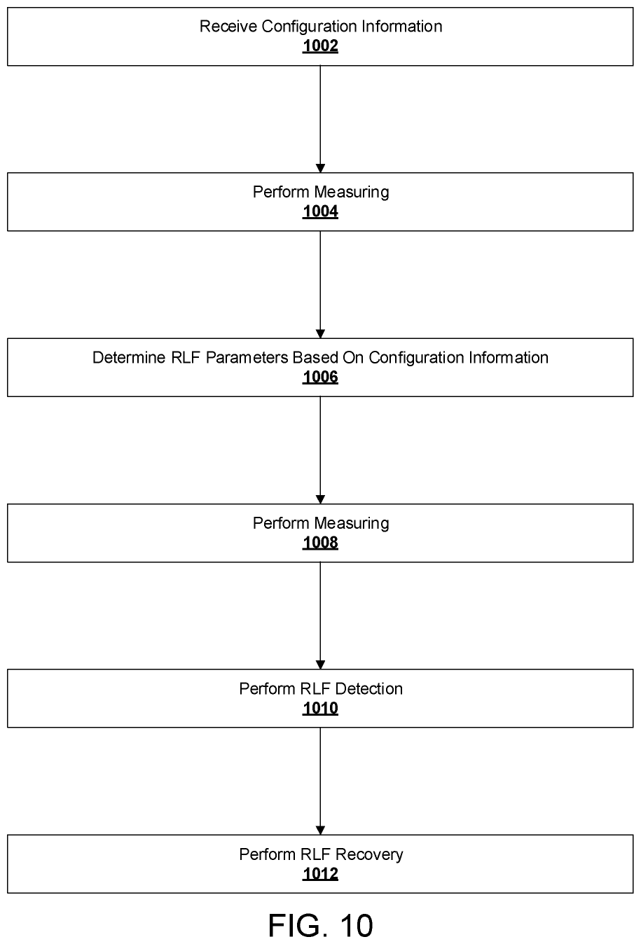

FIG. 10 illustrates an example of a RLF process according to one or more approaches described herein. At 1002, a WTRU may receive configuration information, wherein the configuration information includes one or more sets of radio link failure (RLF) detection parameters for a first radio link and a threshold for at least one metric of a second radio link, wherein at least one set of the one or more sets of RLF parameters comprises at a least RLF timer value and an RLF counter value. At 1004, the WTRU may measure the at least one metric of the second radio link. At 1006, the WTRU may determine a set of RLF detection parameters to use out of the one or more sets of RLF detection parameters based on the measurement of the at least one metric of the second radio link meeting the threshold for the at least one metric of the second radio link. At 1008, the WTRU may measure the first radio link. At 1010, the WTRU may perform RLF detection based a result of the measurement of the first radio link in accordance with the determined set of RLF detection parameters. At 1012, the WTRU may perform an RLF recovery procedure of the first radio link based on a result of performing RLF detection.

In one example, a remote WTRU is configured with multipath and a configuration that enables RLF detection on Uu which depends on the radio and load conditions on the SL. The remote WTRU may be configured with multipath (e.g., one path via Uu and a second via relay). The remote WTRU may be configured with multiple sets of configurations for Uu RLF timers and counters, each set corresponding with a given range of SL RSRP/RSRQ values and/or SL CBR. The remote WTRU may monitors the SL radio and congestion conditions, and may choose the appropriate timer and counter values for Uu RLF detection. The remote WTRU may perform Uu RLF detection based on the chosen RLF timers and counter values. If Uu RLF is triggered, the remote WTRU may perform RRC re-establishment, MCG-failure like recovery of the Uu via the SL, or SCG-failure like recovery of the Uu via the SL.

In one example, a remote WTRU is configured with multipath and a configuration that enables RLF detection on the SL which depends on the radio conditions of the Uu. The remote WTRU may be configured with multipath (e.g., one path via Uu and a second via relay). The remote WTRU may be configured with multiple values of maximum number of consecutive HARQ DTX for SL RLF detection, each value corresponding with a given range of Uu RSRP/RSRQ values. The remote WTRU may monitor the SL radio and congestion conditions, and will choose the appropriate timer and counter values for Uu RLF detection. The remote WTRU may perform SL RLF detection based on the chosen maximum number of consecutive HRAQ DTX. If SL RLF is triggered, the remote WTRU may perform one or more of SL Relay re-selection, MCG-failure like recovery of the SL via the Uu, SCG-failure like recovery of the SL via the Uu, and/or inform the network regarding the SL failure.

In one example, a remote WTRU is configured with multipath and joint RLF detection for the multipath that considers both links at the same time. The WTRU may be configured with multipath (e.g., one path via Uu and a second via relay). The WTRU may be configured with a joint condition for starting T310 related to OOS on Uu and/or HARQ DTX on SL (e.g., N1 consecutive OOS and M1 consecutive DTX lead to the start of T310, and/or, e.g., N2 consecutive OOS or M2 consecutive DTX lead to the start of T310). The WTRU may be configured with a joint condition for stopping T310 related to IS on Uu and/or HARQ feedback reception on SL (e.g., N3 consecutive IS and M3 consecutive HARQ feedback reception on the SL leads to the stop of T310, and/or, e.g., N4 consecutive IS or M3 consecutive HARQ feedback reception on the SL leads to the stop of T310). If T310 expires, the WTRU may perform one or more of RRC re-establishment, MCG-failure like recovery of the Uu via the SL, SCG-failure like recovery of the Uu via the SL, Relay re-selection, MCG-failure like recovery of the SL via the Uu, SCG-failure like recovery of the SL via the Uu.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a remote wireless transmit receive unit (WTRU), the method comprising:
receiving configuration information, wherein the configuration information includes one or more sets of radio link failure (RLF) detection parameters for a first radio link and a threshold for at least one metric of a second radio link;
measuring the at least one metric of the second radio link;
determining a set of RLF detection parameters to use out of the one or more sets of RLF detection parameters based on the measurement of the at least one metric of the second radio link meeting the threshold for the at least one metric of the second radio link;
measuring the first radio link;
performing RLF detection based on a result of the measurement of the first radio link in accordance with the determined set of RLF detection parameters; and
performing an RLF recovery procedure of the first radio link based on a result of performing RLF detection.

2. The method of claim 1, wherein at least one set of the one or more sets of RLF parameters comprises at a least RLF timer value and an RLF counter value.

3. The method of claim 1, wherein the at least one metric comprises load conditions measuring CBR/CR or comprises radio conditions measuring RSRP/RSRQ.

4. The method of claim 1, wherein the RLF recover procedure includes one of re-establishing a failed link, or performing master cell group or secondary cell group failure recovery via a sidelink.

5. The method of claim 1, wherein the second radio link is a sidelink between the remote WTRU and a relay WTRU and the first radio link is a direct link between the relay WTRU and a base station.

6. The method of claim 1, wherein the first radio link is a sidelink between the remote WTRU and a relay WTRU and the second radio link is a direct link between the relay WTRU and a base station.

7. A remote wireless transmit receive unit (WTRU), the WTRU comprising:
a processor operatively connected to a transceiver, the processor and transceiver configured to receive configuration information, wherein the configuration information includes one or more sets of radio link failure (RLF) detection parameters for a first radio link and a threshold for at least one metric of a second radio link;
means for measuring the at least one metric of the second radio link;
the processor and transceiver configured to determine a set of RLF detection parameters to use out of the one or more sets of RLF detection parameters based on the measurement of the at least one metric of the second radio link meeting the threshold for the at least one metric of the second radio link;
the processor and transceiver configured to measure the first radio link;
the processor and transceiver configured to perform RLF detection based on a result of the measurement of the first radio link in accordance with the determined set of RLF detection parameters; and
the processor and transceiver configured to perform an RLF recovery procedure of the first radio link based on a result of performing RLF detection.

8. The WTRU of claim 7, wherein at least one set of the one or more sets of RLF parameters comprises at a least RLF timer value and an RLF counter value.

9. The WTRU of one of claim 7, wherein the at least one metric comprises load conditions measuring CBR/CR or comprises radio conditions measuring RSRP/RSRQ.

10. The WTRU of one of claim 7, wherein the RLF recover procedure includes one of re-establishing a failed link, or performing master cell group or secondary cell group failure recovery via a sidelink.

11. The WTRU of one of claim 7, wherein the second radio link is a sidelink between the remote WTRU and a relay WTRU and the first radio link is a direct link between the relay WTRU and a base station.

12. The WTRU of one of claim 7, wherein the first radio link is a sidelink between the remote WTRU and a relay WTRU and the second radio link is a direct link between the relay WTRU and a base station.
